(19) United States
(12) Patent Application Publication
(10) Pub. No.: US 2007/0198379 A1
(43) Pub. Date: Aug. 23, 2007

(54) Systems and methods for facilitating real property transactions

(76) Inventor: Michael S. Hynek, Dallas, TX (US)

Correspondence Address: DOCKET CLERK, P.O. DRAWER 800889, DALLAS, TX, 75380, US

(21) Appl. No.: 11/634,802

(22) Filed: Dec. 6, 2006

Related U.S. Application Data
(60) Provisional application No. 60/742,591, filed on Dec. 6, 2005.
(60) Provisional application No. 60/742,819, filed on Dec. 6, 2005.

(51) Int. Cl. G06Q 40/00

(52) U.S. Cl. 705/35

(57) ABSTRACT

This patent document discloses systems and methods for generating additional revenue by facilitating real property transfers or the financing of real property. One example method includes facilitating a sale of a real property by securing a reservation of a residual right in the real property. Because of the reservation, a seller may sell the real property to a buyer below a price desired by the seller. Another example method includes providing financing for a real property and securing a reservation of a residual right in the real property. The financing may represent a loan provided to a purchaser or owner of the real property. Because of the reservation, the loan may be provided with a lower interest rate and lower up-front fees. The residual right entitles a party associated with the residual right to receive one or more future payments after the sale or financing for the real property occurs.

### CROSS-REFERENCE TO RELATED APPLICATIONS

This application claims priority under 35 U.S.C. § 119(e) to U.S. Provisional Patent Application No. 60/742,591 filed on Dec. 6, 2005 and U.S. Provisional Patent Application No. 60/742,819 filed on Dec. 6, 2005, which are both hereby incorporated by reference.

This application is related to U.S. patent application No. ______ [HYNE03-00002] entitled “SYSTEMS AND METHODS FOR GENERATING FUTURE REVENUE FROM A REAL PROPERTY” filed on Dec. 6, 2006, which is hereby incorporated by reference.

### TECHNICAL FIELD

This disclosure relates generally to property transfers and financing of real property. More specifically, this disclosure relates to systems and methods for using residual rights to facilitate transfers of real property, financing of real property, and/or marketing or leveraging property transfer services or financing services associated with real property.

### BACKGROUND

Millions of property transfers occur every year in the United States and around the world. These property transfers include sales of raw land, improved land, residential properties, or commercial properties. These transfers generally involve various parties, such as a seller who is selling a real property, a purchaser who is buying the real property and, in some cases, a mortgage company or other lender who finances the purchase of the real property by the purchaser.

Various parties involved in transfers or proposed transfers, financing, or refinancing of real property often face difficult decisions. For example, a seller and a prospective purchaser often must negotiate a price for a real property being offered for sale. Often times, a seller and a prospective purchaser are unable to reach an agreement on a price for a real property. As a particular example, a seller could be willing to sell a real property for $525,000, while a prospective purchaser may be willing to pay only $500,000. In the past, barring any contributions from other parties, the seller had to agree to sell the real property for less, the prospective purchaser had to agree to buy the real property for more, or the seller did not sell the real property to the prospective purchaser. Likewise, the prospective purchaser was not able to buy the real property. The seller and prospective purchaser typically lacked a mechanism for bridging the gap between the seller's lowest selling price and the prospective purchaser's highest purchase price. As a result, many real property transfers could not occur because of disagreements over the price of the real property.

As another example, mortgage companies and other lenders often make money in one of two ways. Typically, a mortgage company or other lender may charge a higher interest rate for a loan with little or no up-front fees, or the mortgage company or other lender may charge a lower interest rate with higher up-front fees for the loan. The up-front fees typically take the form of “points,” where one point represents one percent of the loan. As a result, a purchaser of a real property or a borrower often had to decide whether to accept a higher interest rate or higher up-front fees when obtaining a loan for the purchase of the real property or when financing or refinancing a real property. The purchaser or borrower typically lacked a mechanism for obtaining both a lower interest rate on a loan while paying lower or no up-front fees for the loan.

As a third example, in many instances, the mortgage industry includes companies that originate mortgages and then sell packages of these mortgages to mortgage servicing companies. The mortgage companies that originate loans usually make money from fees (including points on a loan) charged during the mortgage origination process and from selling the packages of mortgages to a servicing company. Many mortgage companies sell packages of mortgages to generate capital so that they can make new mortgages. These companies often prefer making fees and profits associated with originating and selling the mortgages, as opposed to fees and profits associated with servicing and owning the mortgages. A mortgage and its associated documents provide the basis for all of the terms and security for the mortgage, and these documents are typically transferred to a purchasing party when the mortgage is sold. An originating mortgage company typically has lacked a mechanism that would allow it to collect fees after selling a mortgage.

As a fourth example, multiple entities may be involved in real property transfers. These entities include but are not limited to, one or more real estate agents, mortgage brokers, mortgage companies, attorneys, title companies, inspectors, appraisers, and surveyors. In most cases, these entities may participate in a particular real property transfer, but they typically lack an opportunity to leverage their prior participation in the real property transfer into subsequent transfers of the same or partially the same real property.

### SUMMARY

To address these or other deficiencies of the prior art, this patent document broadly discloses systems and methods for facilitating transfers of real property, financing of real property, and/or the marketing or leveraging of services for real property transfers using residual rights in real properties. These residual rights may provide a right to income or a stream of income to a holder of the rights.

Income or a stream of income associated with a residual right may be triggered by any number of events or other circumstances. For example, one or more payments may become due under a residual right upon a transfer of the real property, a financing or refinancing of the property, an expiration of a period of time, a rezoning of the property, a particular use of the property, or an increase in the value of the property.

Accordingly, a seller or lender may accept a reduction in the present value paid to it with respect to a real property transaction, in exchange for the future value associated with a residual right. Also, a buyer may enter into a transaction with a reduction in the present value paid, with an understanding that future value associated with a residual right may be recognized in the future. In addition, no payment may be due under a residual right if a current owner or prospective buyer of a real property uses the service of a particular entity. However, a payment may be due under a residual right if the current owner or prospective buyer of a real property does not use the service of a particular entity.

According to one example embodiment, a transaction involving a real property is facilitated by securing a reservation of a residual right in the real property. The residual right entitles a party associated with the residual right to receive one or more future payments after the transaction. Each of the one or more future payments is owed in response to a triggering event. In this way, for example, a seller is able to sell the real property and eventually receive additional proceeds, which otherwise would not have been available.

In particular example embodiments, a purchaser or owner of real property is desirous of obtaining a loan on or refinancing for the real property, collateralized by the real property (such as by obtaining a mortgage or refinancing the real property). A loan company agrees to provide a loan to the purchaser or owner on the condition that the purchaser or owner grants and conveys a residual right to the loan company. The residual right entitles a party associated with the residual right to receive one or more future payments after the loan is provided to the purchaser or owner. Each of the one or more future payments may be owed, for example, in response to a triggering event. Accordingly, the loan company may provide the financing at a reduced rate (such as lower or no up-front fees and/or a lower interest rate) and eventually receive additional proceeds, thereby facilitating the providing of the financing.

In other particular example embodiments, a real property may be sold for which an owner thereof is to be entitle to particular services or amenities, such as a quality school system or the use of sporting facilities associated with a residential or commercial development. However, a purchaser of the real property may not be able to, or may not wish to, bear the full cost of such services or amenities in the purchase price of the real property. Accordingly, a seller may sell the real property to a purchaser at a reduced sales price and reserve a residual right in the real property. The residual right provides an economic interest in the real property, which entitles a party associated with the residual right to receive one or more future payments after the sale of the real property to the purchaser. Each of the one or more future payments may be owed, for example, in response to a triggering event. Proceeds associated with the residual right, as may be collected from time to time as triggering events occur, may be utilized to fund the aforementioned services or amenities, thereby providing the desired amenities without an unacceptable increase in the initial acquisition cost of the real property and thus facilitating the sale of the real property. The residual right may be transferred, such as to an entity responsible for the services or amenities (like a home owners' association) and thereby provide an interest in the real property benefiting from the services or amenities for a direct source of funding.

In still other particular embodiments, the residual right may be designed to return (1) at least a difference between a value of the real property as perceived by a seller of the real property and a value of the real property as perceived by a buyer of the real property, (2) at least a difference between a financing fee desired by a lender associated with the transaction and a financing fee paid in association with the transaction, or (3) at least a difference between a fee desired by a service provider providing a service associated with the transaction and a fee actually paid to the service provider.

In a related example embodiment, a system includes a memory capable of storing information identifying a residual right in a real property. The residual right was established as part of a prior transaction involving a real property. The residual right entitles a party associated with the residual right to receive one or more future payments in response to one or more triggering events. The system also includes a processor capable of detecting at least one of the one or more triggering events associated with the residual right and initiating at least one of the one or more payments in response to the at least one detected triggering event.

In another related example embodiment, a computer program is embodied on a computer readable medium and is operable to be executed by a processor. The computer program includes computer readable program code for detecting a triggering event associated with a residual right affecting a real property. The residual right was established as part of a prior transaction for the real property. The residual right entitles a party associated with the residual right to receive an additional payment in response to the triggering event. The computer program also includes computer readable program code for initiating the additional payment in response to the triggering event.

The foregoing has outlined rather broadly the features and technical advantages of the present invention so that those skilled in the art may better understand the DETAILED DESCRIPTION OF EXAMPLE EMBODIMENTS that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF EXAMPLE EMBODIMENTS below, it may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, including, be included within, interconnect with, contain, containing, be contained within, connect to or with, have some correlation with, couple to or with, be communicable with, cooperate with, interleave, juxtapose, be proximate to, be bound to or with, have, have a property of, or the like. The terms “processor” and “controller” mean any device, system, or part thereof that controls at least one operation and may be implemented in hardware, firmware, software, or some combination of at least two of the same. It should be noted that the functionality associated with any particular processor or controller may be centralized or distributed, whether locally or remotely. The phrase “function of” may mean based upon, as a result of, because of, dependent on, or the like. Definitions for other words and phrases are provided throughout this patent document, and those of ordinary skill in the art should understand that these definitions apply to prior as well as future uses of such defined words and phrases.

### BRIEF DESCRIPTION OF DRAWINGS

For a more complete understanding of this disclosure, reference is now made to the following description, taken in conjunction with the accompanying drawings, in which:

FIGS. 1A and 1B illustrate example systems for identifying residual rights associated with real properties according to one embodiment of this disclosure;

FIG. 2 illustrates an example method of a seller generating additional revenue by facilitating a real property transfer using a residual right according to one embodiment of this disclosure;

FIG. 3 illustrates an example method of a lender generating additional revenue by facilitating the financing of a real property using a residual right according to one embodiment of this disclosure;

FIG. 4 illustrates an example method of a service provider generating additional revenue by facilitating a real property transfer using a residual right according to one embodiment of this disclosure; and

FIG. 5 illustrates an example method of reserving a residual right associated with a real property according to one embodiment of this disclosure.

### DETAILED DESCRIPTION OF EXAMPLE EMBODIMENTS

In accordance with the disclosure of U.S. patent application No. ______ [HYNE03-00002] entitled “SYSTEMS AND METHODS FOR GENERATING FUTURE REVENUE FROM A REAL PROPERTY,” parties such as developers, builders, owners, or others are provided with a mechanism for reserving or otherwise securing a residual right in a real property. The residual right entitles a party to receive revenue, such as a fee owed in response to one or more triggering events. The triggering events could include, among other things, a transfer of an interest (such as a sale, lease, assignment, or rental) in a real property, payment of property taxes for the real property, a time interval (such as a year, decade, etc.) elapsing, a foreclosure of the property, or other event. The triggering events could also include a finance or refinance of the property, a title of the property being researched, a release of an encumbrance (such as a lien or deed of trust) affecting the property, a renewal of a lease or rental agreement affecting the property, or the occurrence of some other event. Also, the fee could represent any type of fee, such as a fixed fee that remains constant or is specific during certain time intervals. The fee could also be variable, such as a fee that increases each year by a specified percentage or that is based on an appraised value, a value assessed by a taxing authority, a sales price of the property, or an increase in a current sales price of the real property over a previous sales price. Moreover, the fee may be any combination of the foregoing. In this way, a party may receive revenue even after a real property has been sold many times.

This disclosure recites the use of residual rights to facilitate a sale or other transfer of a real property, to facilitate the financing of a real property, and/or to market or leverage property transfer services or financing services. In this document, the phrase “real property” refers to property such as land, that which is incidental or appurtenant to land (such as a structure), that which is immovable by law, or any combination thereof. For example, a seller and a prospective purchaser may be unable to agree upon a sales price for a real property. In response, the seller may agree to accept a lower sales price for the real property, and the seller then reserves a residual right in the real property. The residual right may entitle the seller to receive, at a later time, one or more additional payments from the purchaser or from future owners of the real property.

As a particular example, the seller could wish to receive $525,000 for a real property, but the seller may agree to sell the property to a purchaser for $500,000. In addition to the sale proceeds, the seller could also reserve a residual right in the real property, entitling the seller to receive a fee one or more times when or each time the real property is sold again in the future. In this example, the fee could represent one percent of a future sales price of the real property. In this way, the seller may be able to sell the real property at a lower price or at the purchaser's desired price, but the seller may receive additional payments in the future. The purchaser is able to purchase the real property at a lower price or at the purchaser's desired price, although the purchaser or future purchaser may be required to pay the seller an additional fee associated with the residual right. This may allow more property transfers to take place by facilitating negotiations between sellers and purchasers.

Such an embodiment is useful, for example, to facilitate a sale of real property in a situation where the seller's and purchaser's views of the value (or future value) of the real property differ. A seller of the real property may, for example, be of the belief that the property will greatly appreciate in value in the future, whereas the purchaser's view is that the real property will not appreciate as rapidly as the seller believes. Accordingly, each party's present value determination of the real property may differ. However, using residual rights of the present invention, the seller may reserve the right to future proceeds, perhaps tied to the future value of the real property in some way (such as appraised value, event such as rezoning or construction of nearby infrastructure raising the value, and/or the like). Accordingly, the seller may be willing to accept the purchaser's present value purchase price, believing that the seller will receive additional proceeds to meet his or her valuation of the real property at a later date.

As another example, a lender (such as a mortgage company) could agree to provide a loan to a purchaser or owner of a real property (such as a mortgage loan or a refinance loan). Rather than charging the purchaser or owner an up-front fee in the form of one or more points, the lender could provide a lower interest rate for the loan and retain or be given a residual right in the real property. The residual right could entitle the lender to receive one or more payments in the future, such as a fee due in response to a time interval (like a year) elapsing or a sale of the real property. In this way, the purchaser or owner may receive a lower interest rate for a loan and be required to pay less or no up-front fees, while the lender is able to receive additional revenue from the purchaser or owner and/or from future owners of the real property.

Such an embodiment is useful, for example, to facilitate financing or refinancing where a purchaser or owner cannot, or does not wish to, pay the lender's fees in an up-front payment and/or does not wish to pay a higher interest rate. A purchaser of real property may, for example, be reluctant to pay large fees to a lender at closing, such as to reserve capital for improvements to the real property. Likewise, the purchaser of the real property may believe a particular interest rate results in unacceptable payments. Accordingly, the purchaser and lender may agree to a financing arrangement where the purchaser receives reduced lenders' fees at closing and a desirably low interest rate for the loan. The purchaser is obligated to provide a residual right to the lender to provide future proceeds to the lender, perhaps payable upon an anniversary of the loan or upon resale of the real property.

As a third example, a real estate agent could be involved in a sale, purchase, or other transaction involving a real property. The real estate agent is typically paid based on a percentage of the sale or purchase price (often three percent). However, the real estate agent could agree to accept a lower fee in exchange for a residual right in the real property. For example, the real estate agent could agree to a one-percent fee from a real property purchaser in exchange for a residual right in the property. In some embodiments, a fee (such as one percent) is due upon one or more subsequent transfers involving the property. In other embodiments, no fee may be due under the residual right if the same purchaser later uses the same real estate agent to sell the real property. However, a payment (such as one percent) may be due under the residual right if the purchaser does not use the real estate agent to sell the real property.

While the above description has described the use of residual rights by particular parties (sellers, owners of real property, mortgage companies or other lenders, purchasers, and real estate agents), residual rights may be used by any appropriate party to facilitate the financing or sale of real property and/or the marketing or leveraging of property transfer services. The residual rights could also be used by any party with a claim to or involving a real property to receive other payments owed by an owner of the real property. For example, a lien holder, a lender, a taxing authority, the Internal Revenue Service (IRS), or some other party with a claim to the real property may obtain or be granted a residual right in the real property. In this way, the party with a claim to or involving the real property may be able to use the residual right to, for example, obtain money owed to that party by the owner of the real property. For example, the owner of the real property may fail to make a required payment (such as income taxes or property taxes), and the residual right may be obtained by or granted to the taxing authority by the owner of the real property to stop other actions, such as a tax foreclosure by the taxing authority in response.

In this document, the phrase “residual right” refers to a right associated with a real property that is retained or granted to an individual or entity for the purpose of generating future revenue without any right to use or otherwise enjoy the real property with which the residual right is associated. A residual right is a retained interest in the real property and may be held by the owner of real property reserving the right or granted to another individual or entity. Rights to future revenue provided by residual rights may provide payment of such revenue to a holder of the residual rights or to another individual or entity. Residual rights may be recordable as an interest in real property and enforceable using typical real property ownership rights enforcement mechanisms and techniques. A real property may be subject to one or multiple reservations of a residual right. The residual right is said to be established by a “reservation” affecting the real property, and the property is said to be “encumbered” by the reservation.

A residual right is different from a mortgage in several ways. For example, with conventional mortgages, a purchaser typically buys most or all of a seller's interest in a real property, and the purchaser pledges that interest as security for a mortgage. In other words, with a typical mortgage, the purchaser's interest in the real property acts as collateral for the loan. Failure to repay a mortgage allows the mortgage company to take possession of and sell the real property. With a residual right, no interest or a reduced interest in a real property is pledged as collateral. Rather, the residual right represents a direct right or an economic interest in real property that is separated from the remainder of the rights in the real property (as may be held by one or more different individuals). A residual right is separated from the “bundle” of property rights by an owner, much like mineral rights may be reserved in real property when the remainder of the property rights are transferred. Residual rights differ from the aforementioned mineral rights, and similarly from easements and other reservations of rights, in that residual rights include a right to future proceeds without any right to use or otherwise enjoy the real property with which the residual rights are associated. A residual right may be held or transferred by the original owner, such as to a mortgage company or other party who helped complete or finance a transfer of interest in the property or to a service provider (such as a school system or home owners' association, an unrelated party, etc.).

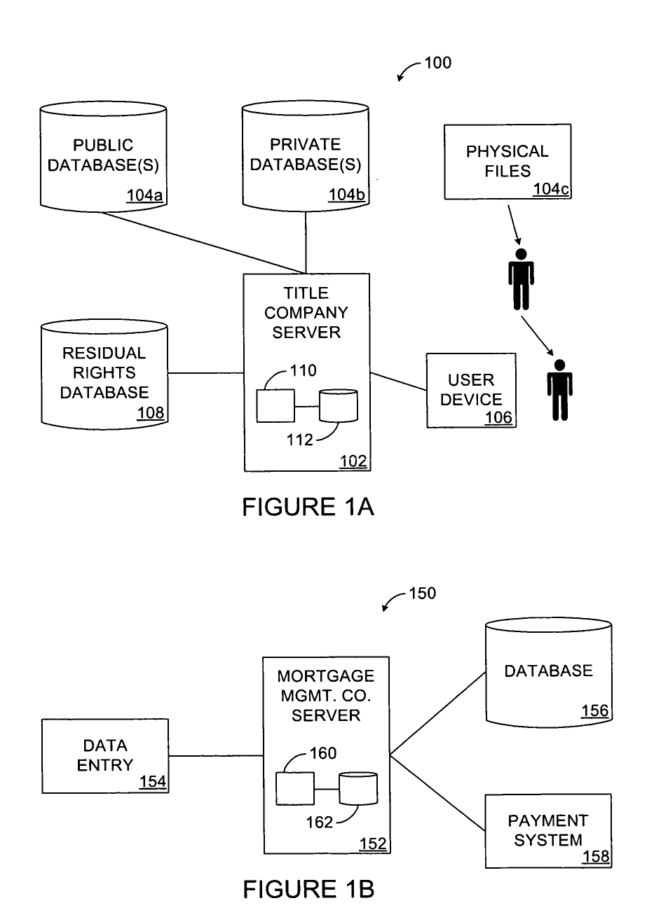

FIGS. 1A and 1B illustrate example systems 100 and 150 for identifying residual rights associated with real properties according to one embodiment of this disclosure. In these examples, the system 100 is used by a title company, attorney, or other applicable party (collectively referred to here as “title company”), and the system 150 is used by a mortgage management company. The systems 100 and 150 shown in FIGS. 1A and 1B are for illustration only. Other systems may be used to facilitate real property transfers or the financing of real property and to identify residual rights associated with real properties without departing from the scope of this disclosure.

The system 100 in FIG. 1A may be used by a title company. In general, a title company analyzes title documents to determine if a title policy or commitment for title insurance should be issued for a transfer of an interest in a real property. For example, the title company may use the title documents to determine whether a party attempting to sell a property has a valid interest to sell.

As shown in FIG. 1A, the system 100 includes a title company server 102, multiple title document sources 104a-104c, and a user device 106. The system 100 may also include a residual rights database 108. The title company server 102 represents a computing device capable of retrieving information related to a real property, such as raw or improved land, a residential property, or a commercial property. For example, a user (such as title company personnel) could provide the title company server 102 with the physical address of a property, and the title company server 102 could retrieve (or be provided, in the case of physical files 104c) information about the property from various data sources. The title company server 102 then provides the collected information to the user for review and/or analysis. As a specific example, the title company server 102 could retrieve title documents from the data sources 104a-104b.

The title company server 102 includes any hardware, software, firmware, or combination thereof for retrieving and processing information related to a property. In particular embodiments, the title company server 102 includes at least one processor 110 and at least one memory 112 capable of storing instructions and data used by the processor 110. Embodiments of title company server 102 may include communications interfaces (such as a network interface, modem, or wireless communication interface) and/or various input/output devices (such as a facsimile machine, optical scanner, barcode reader, magnetic stripe reader, radio frequency identification tag reader, printer, keyboard, pointing device, or touch screen) to accommodate input and/or output of relevant information in appropriate ways.

The title document sources 104a-104c represent data sources containing title documents associated with properties. In this example, the title document sources 104a-104c include a public title document source 104a, a private title document source 104b, and a physical title document source 104c. In particular, the public title document source 104a and the private title document source 104b represent electronic databases, while the physical title document source 104c represents a physical, non-electronic source of title documents.

The public title document source 104a represents any suitable public source of title documents, such as an electronic database of records maintained by a county government. The private title document source 104b represents any suitable private source of title documents, such as an electronic database of records maintained by a private company, title company, or group of title companies. The physical title document source 104c represents any suitable public or private source of physical title documents, such as a physical records storage facility maintained by a county government or micro-fiche files maintained by a county government, a private company, or a title company. Appropriate information in the physical title document source 104c may be provided to title company server 102, such as via user device 106.

The public and private title document sources 104a-104b may be accessed electronically by the title company server 102. The title company server 102 then retrieves title documents related to a property based, for example, on the particular physical address of the property. Title documents in the physical title document source 104c may be searched manually. Each of the title document sources 104a-104c represents any suitable source of title documents. While FIG. 1A illustrates the use of three title document sources 104a-104c, the system 100 could include any number and type of title document sources (whether electronic or physical).

The user device 106 allows a user to interact with and control the title company server 102. For example, the user device 106 may allow a user (such as title company personnel) to provide search criteria (such as a property's physical address) to the title company server 102 so that a search for title documents can be performed. Also, the user device 106 allows a user to view the title documents located and retrieved by the title company server 102. The user device 106 includes any hardware, software, firmware, or combination thereof for interacting with the title company server 102. The user device 106 could, for example, represent a desktop computer, laptop computer, terminal, mobile telephone, or personal digital assistant.

In one aspect of operation, personnel of a title company provide search criteria for a property to the title company server 102, and the title company server 102 performs a search to locate title documents related to the property. The located title documents are provided to the user device 106 for review by the title company personnel. A search of physical title documents may also be performed manually, and any located title documents are provided to the title company personnel for review. The title company personnel use the located title documents to determine if a title policy or title insurance should be issued for a transfer an interest in the property. For example, the title company personnel may use the title documents to determine whether a party attempting to sell a property has a valid interest to sell.

As described above, the property may have an associated residual right establishing a fee that is due to a prior owner, mortgage company or other lender, or other party who helped facilitate a prior sale of a real property or a finance of the real property. For example, the seller or buyer of the property may be required to make a payment to a prior owner or a mortgage company, where the payment is associated with a residual right reserved as part of the financing provided by the prior owner or mortgage company. The title company personnel use this information to ensure that the payment is collected at the appropriate time and provided to the appropriate recipient(s).

The title company personnel may use the foregoing information to require satisfaction of a right to payment under the residual right (such as one or more payments currently due and owing, although additional payments may become due and owing at a later date), preventing completion of a transaction associated with the property until the right/obligation to/of payment is satisfied. Specifically, the title company personnel may ensure that any payments due and owing in association with a residual right associated with the property are paid or are to be paid before issuing a title policy or title insurance. For example, the title company personnel may establish, as a condition of issuing a title policy or title insurance, that the payments with respect to the identified residual right must be brought current as a condition precedent to the title policy or title insurance becoming effective. Such may be accomplished by a closing agent associated with the property transaction collecting the appropriate payment from the transaction proceeds and placing the amount in escrow for the appropriate recipient(s).

The existence of the residual rights may be determined using any suitable information. For example, a residual right may be established in a deed or other title document recorded by an owner of the property (previous or present) and/or by an owner of the residual right. In this case, the title company server 102 and/or title company personnel may retrieve a title document establishing a residual right, or a manual search of the physical title documents may lead to the discovery of a title document containing a residual right. The title company personnel would then identify the residual right upon review of the documents.

Instead of or in addition to this, information about residual rights for one or multiple properties may be stored in a residual rights database 108. The residual rights database 108 may store information identifying various residual rights associated with various properties. The residual rights database 108 could also store information identifying conditions associated with the residual rights. For example, a residual right could be in effect only for a limited time or for a limited number of transactions, such as when the residual right requires a fee for each of the first five sales of a property.

In addition, the database 108 could store information identifying the party or parties that are to receive a residual right payment. For example, a residual right could initially be owned by a single party, and the database 108 could identify that party. As time goes on, the residual right could be passed on to that party's heirs or sold to one or more other parties, and the database 108 could identify those heirs or other parties. As a particular example, the database 108 may store information tracking the estates of prior owners of residual rights, allowing the title company to identify a prior owner's heirs who are to receive a residual right payment. The database 108 includes any hardware, software, firmware, or combination thereof for storing and facilitating retrieval of information.

Information in the residual rights database 108 may be provided by a property owner, a residual rights owner, a governmental agency (such as a county clerk), or any other party. The residual rights database 108 may comprise a centralized or distributed database for recording residual rights, and information in the residual rights database 108 may be provided by multiple entities. Accordingly, the residual rights database 108 may comprise a database of residual rights identified with respect to transactions handled by one or more service providers.

The system 150 in FIG. 1B may be used by a mortgage management company. In general, a mortgage management company receives and manages mortgage payments for real property (such as residential or commercial properties). The mortgage management company may also receive payments for escrow accounts maintained for owners of the managed properties. The escrow accounts could be used to collect estimated property taxes and hazard insurance premiums for the managed properties. In addition, the mortgage management company may collect money from property owners to make any payments needed to satisfy residual rights affecting the managed properties.

As shown in FIG. 1B, the system 150 includes a mortgage management company server 152, a data entry device 154, a database 156, and a payment system 158. In this example embodiment, the mortgage management company server 152 may receive information from the data entry device 154 or other source identifying payments received by the mortgage management company. The payments could be received electronically, by check in the mail, or in any other suitable manner. The server 152 may take any suitable action, such as crediting the appropriate accounts with the received payments. As a particular example, the server 152 may credit the appropriate mortgage account for a received mortgage payment and credit the appropriate escrow account for property tax and insurance premium payments. The server 152 may also credit the appropriate escrow account for future residual right payments.

The mortgage management company server 152 includes any hardware, software, firmware, or combination thereof for managing mortgage or other payments for one or more managed properties. In particular embodiments, the mortgage management company server 152 includes at least one processor 160 and at least one memory 162 capable of storing instructions and data used by the processor 160.

The data entry device 154 is coupled to the server 152. The data entry device 154 represents any suitable device capable of providing information about mortgage or other payments to the server 152. The data entry device 154 could, for example, represent a scanning device that scans received checks and payment stubs for account numbers and paid amounts. The data entry device 154 could also represent a user device where a user manually enters information about mortgage payments. While a single data entry device 154 is shown in FIG. 1B, multiple data entry devices 154 could be used in the system 150.

Information about the received payments may be stored in the database 156. For example, the database 156 (such as may correspond to or include information from residual rights database 108 of FIG. 1A) could store information identifying the current status of a mortgage for a managed property and the payment history of the mortgage. The database 156 could also store information identifying the current status of an escrow account associated with a managed property. In addition, the database 156 could store information identifying residual rights associated with the managed properties. The information about the residual rights could include the parties to whom payments are owed (including the heirs of prior residual right owners), the amounts of the payments, and any events that trigger payments. The payments could, for example, be owed to a prior owner or to a mortgage company (which could represent or be associated with the mortgage management company) or other lender. The server 152 may use this information to ensure that the residual right payments are made at the appropriate times and to the appropriate parties, such as by detecting a triggering event and making a residual right payment in response to the event. As particular examples, the server 152 could ensure that the residual right payments are made when property taxes are paid, when specified time periods elapse, or when interests in the properties are transferred. The database 156 includes any hardware, software, firmware, or combination thereof for storing and facilitating retrieval of information.

The payment system 158 allows the system 150 to make or receive payments to or from appropriate entities. For example, the payment system 158 may allow the system 150 to pay municipalities for property taxes and to pay insurance companies for hazard insurance policies. The payment system 158 may also allow the system 150 to make payments required by residual rights to the appropriate party when a triggering event occurs for a particular property. The payment system 158 could allow these payments to be made electronically, by check, or in any other suitable manner. The payment system 158 may also allow the system 150 to receive electronic payments for mortgages and other types of payments. The payment system 158 includes any hardware, software, firmware, or combination thereof for sending or receiving payments associated with the operation of the mortgage management company.

Although FIGS. 1A and 1B illustrate examples of systems 100 and 150 for identifying residual rights associated with real properties, various changes may be made to FIGS. 1A and 1B. For example, the use of residual rights and payments for facilitating real property transfers, the financing of real property, the marketing or leveraging of property transfer or financing services, and identifying residual rights associated with real properties could be used in any other context by any other person or entity. Also, while the residual rights have been described as being specified in title documents, residual rights could be established in any other type of document or in any other suitable manner. In addition, the use of residual rights could be used by any other party and is not limited to use with a property transfer involving a prior owner or mortgage company.

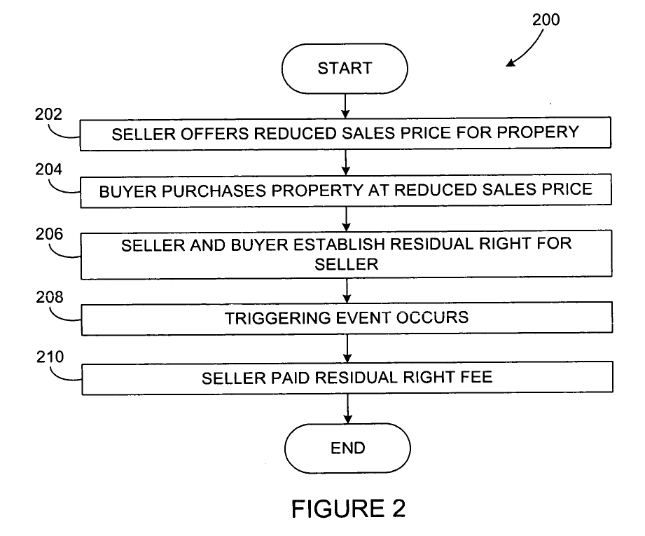

FIG. 2 illustrates an example method 200 of a seller generating additional revenue by facilitating a real property transfer using a residual right according to one embodiment of this disclosure. For ease of explanation, the method 200 is described with respect to a seller attempting to sell a real property. The method 200 could be used by any other party and with any suitable property.

A seller offers a reduced sales price for a property at step 202. This may include, for example, an owner offering to sell a property at a sales price that is less than the owner's desired price. The reduced sales price could also represent a price offered by a potential buyer of the property, which is below the owner's desired price.

The potential buyer purchases the property at the reduced sales price at step 204. This may include, for example, the buyer and the seller entering into a sales contract for the property, where the sales contract includes the reduced price for the property. This may also include the buyer and the seller closing on the property by signing a deed and any other paperwork or legal documents required to transfer title of the property from the seller to the buyer.

The seller and the buyer agree upon a residual right for the benefit of the seller that is reserved to the seller at step 206. This may include, for example, the seller and the buyer signing and recording a deed or other title document establishing the residual right. The purchase of the property at step 204 and the establishment of the residual right at step 206 may overlap. For example, the residual right could be established in a document used to transfer title of the property from the seller to the buyer.

The residual right may establish a right to payment to a holder thereof, such as upon the occurrence of a triggering event at a later date. In this way, the seller may reserve a right to further income from the real property in addition to the sales price. This residual right to income may be transferred, mortgaged, pledged, or held by the seller just as any interest in real property. The residual right itself may establish limitations, such as restrictions on transfer and/or other terms, such as a reverter to the dominant property estate upon an event or at a particular time.

The residual right could include a restriction prohibiting or limiting the ability of subsequent residual rights being established with respect to the real property. For example, a residual right may specify that no or no other residual rights are permitted with respect to the associated real property. Alternatively, a residual right may specify limitations, such as a total dollar amount or a maximum percentage of the value of the real property, for any residual rights in the aggregate permitted with respect to the associated real property. Such prohibitions or limitations may themselves be limited. For example, once a residual right establishing that the residual right is exclusive (by prohibiting the ability of subsequent residual rights being established) expires or is otherwise no longer associated with any future payments (such as when the residual right establishes a payment associated with a specific number of subsequent transactions or a date certain for its termination), the aforementioned prohibitions or limitations may also be extinguished.

A triggering event occurs at step 208. The triggering event could represent, for example, a period of time (such as a year or number of years) elapsing after the sale of the property. The triggering event could also represent a subsequent transfer of interest in the property, such as the buyer selling, leasing, or renting the property. The triggering event could further represent payment of property taxes for the property or any other or additional triggering event(s).

In response to the triggering event, the original seller is paid a residual right fee at step 210. This may include, for example, a title company or other entity collecting and providing the payment to the original seller who created the residual right for its benefit. This may also include a mortgage management company collecting money for a residual right payment in an escrow account and making the residual right payment at the appropriate time. As a particular example, this may include a title company collecting the payment at a closing where documents are signed transferring title in the property from the original buyer to a new owner. The residual right may be recorded in the appropriate property records such that a title company's search of the title reveals this interest and its terms. Any subsequent transfer of the real property, or even refinancing of the real property, may thus require satisfaction of the residual right at or before closing, such as by using an escrow account.

In this way, the sale of the property from the original seller to the original buyer may be facilitated, at least in part, using the residual right and its associated payments. The seller may also charge a lower sales price for the property but collect additional monies later. The buyer is able to purchase the property, perhaps at a lower sales price, and may have to make a residual right payment if and when a triggering event occurs.

Although FIG. 2 illustrates one example of a method 200 of a seller generating additional revenue by facilitating a real property transfer, various changes may be made to FIG. 2. For example, various steps shown in FIG. 2 may occur at the same time. Also, the residual right could be transferred from the original seller to a different party, and the residual right payment would then be provided to that other party.

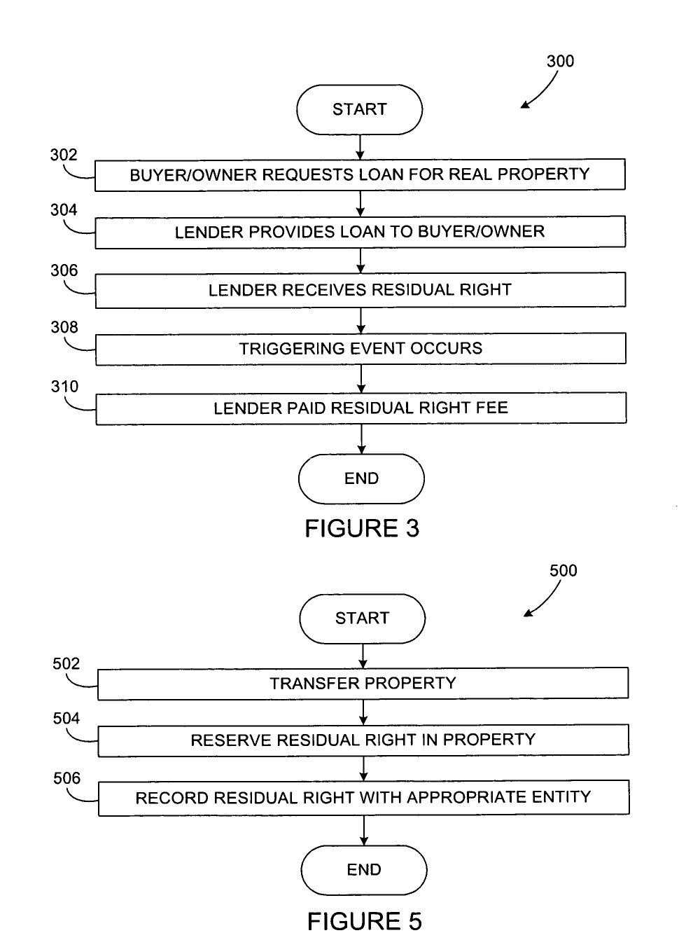

FIG. 3 illustrates an example method 300 of a lender generating additional revenue by facilitating the financing of a real property using a residual right according to one embodiment of this disclosure. For ease of explanation, the method 300 may be described with respect to a lender providing a loan for a real property. The method 300 could be used by any other party and with any suitable property.

A buyer or owner of a property requests a loan from a lender at step 302. This may include, for example, the buyer requesting a particular loan amount for the purchase of a particular property. This may also include an owner requesting a finance using the real property as collateral or a refinance of a particular real property.

The lender provides a loan to the buyer or owner at step 304. This may include, for example, the lender providing the purchase funds to a seller of the property or any appropriate intermediary at a closing for the property on behalf of the buyer, where the seller and buyer sign documents to transfer legal title of the property to the buyer. This may also include the lender paying off a current mortgage during a refinance of the real property.

The lender receives a residual right in the property at step 306. This may include, for example, the buyer or owner signing and recording a title document, or having it recorded, establishing the residual right.

The residual right may establish a right to payment to a holder thereof, such as upon the occurrence of a triggering event at a later date. In this way, the seller may reserve a right to further income from the real property, and this residual right may be granted or transferred to the lender. This residual right to income may be transferred, mortgaged, pledged, or held by the lender just as any interest in real property. Accordingly, the lender may hold the residual right in order to receive proceeds at a later date, or the lender may transfer the residual right for a present value payment or payments.

A triggering event occurs at step 308. The triggering event could represent, for example, a period of time (such as a year or number of years) elapsing after the loan is provided to the buyer or owner. The triggering event could also represent a subsequent transfer of interest in the property or any other or additional triggering event(s).

In response to the triggering event, the buyer or current owner of the property pays the residual right fee to the lender at step 310. This may include, for example, a title company or other entity collecting and providing the payment to the lender if the buyer or owner transfers an interest in the property. This may also include a mortgage management company collecting money for a residual right payment in an escrow account and making the residual right payment at the appropriate time.

In this way, the lender may be able to charge fewer or no up-front fees while providing a loan with a lower interest rate. This also benefits the purchaser or owner of the real property who is obtaining the loan.

Although FIG. 3 illustrates one example of a method 300 of a lender generating additional revenue by facilitating the financing of a real property using a residual right, various changes may be made to FIG. 3. For example, the residual right could be transferred from the lender to a different party, and the residual right payment would then be provided to that other party.

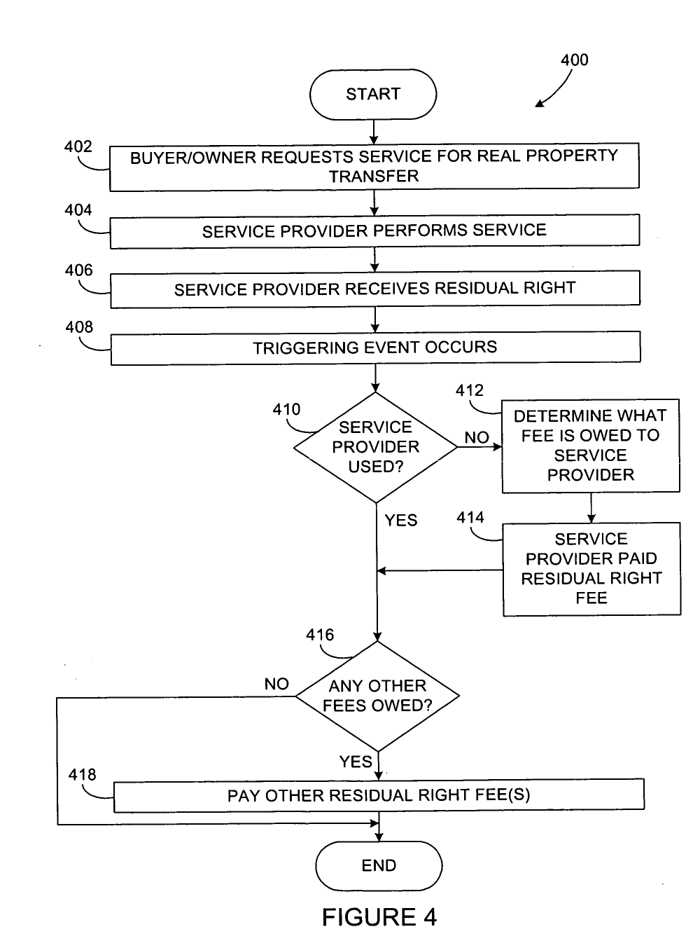

FIG. 4 illustrates an example method 400 of a service provider generating additional revenue by facilitating a real property transfer using a residual right according to one embodiment of this disclosure. For ease of explanation, the method 400 may be described with respect to a real estate agent participating in a sales transaction involving a real property. The method 400 could be used by any other party (such as a lender, mortgage broker, or mortgage company) and with any suitable property transaction.

A buyer or owner of a property requests a service from a service provider at step 402. This may include, for example, the buyer or seller requesting assistance from a real estate agent. This may also include the real estate agent agreeing to provide the requested service at a reduced fee in exchange for a residual right in a real property.

The service provider provides the requested service to the buyer or owner at step 404. This may include, for example, the real estate agent helping the buyer to buy a real property or helping a seller to sell a real property.

The service provider receives a residual right in the property at step 406. This may include, for example, the buyer or owner signing and recording a title document, or having it recorded, establishing the residual right.

The residual right may establish a right to payment to a holder thereof, such as upon the occurrence of a triggering event at a later date. In this way, a right to further income is reserved from the real property, and this residual right may be granted or transferred to the service provider. This residual right to income may be transferred, mortgaged, pledged, or held by the service provider just as any interest in real property. Accordingly, the service provider may hold the residual right in order to receive proceeds at a later date, or the service provider may transfer the residual right for a present value payment or payments.

A triggering event occurs at step 408. The triggering event could represent, for example, a subsequent transfer of interest in the property or any other or additional triggering event(s).

In response to the triggering event, a determination is made as to whether the buyer or seller used the service of the same service provider again to perform some function at step 410. This could include, for example, determining if the buyer of the real property used the same real estate agent to sell the real property or if the seller of the real property used the same real estate agent to buy or sell a different real property. If not, a residual right fee is determined to be owed to the service provider at step 412, and the residual right fee is paid to the service provider at step 414. Otherwise, no fee is due to the service provider. However, one or more additional residual right fees could be owed to other parties (such as a prior lender). A determination is made as to whether the buyer or seller owes a residual right fee to any other party at step 416. If so, a residual right fee is determined and paid to another party at step 418.

Although FIG. 4 illustrates one example of a method 400 of a service provider generating additional revenue by facilitating a real property transfer using a residual right, various changes may be made to FIG. 4. For example, the residual right could be transferred from the service provider to a different party, and the residual right payment would then be provided to that other party.

FIG. 5 illustrates an example method 500 for reserving a residual right associated with a property according to one embodiment of this disclosure. For ease of explanation, the method 500 is described with respect to reserving a residual right and fee associated with a property being sold. The method 500 could be used in any other circumstance, including a finance or a refinance of a real property or to grant a residual right to another party.

A transfer of a property occurs at step 502. This may include, for example, a buyer and a seller of the property executing a deed and any other paperwork or legal documents to transfer title of the property from the seller to the buyer.

A reservation document establishing the residual right is executed by the appropriate parties to reserve or grant a residual right at step 504. This may include, for example, specifying the residual right, a fee associated with the residual right, the party or parties retaining the residual right, and/or to whom fees are to be paid in a title document (such as a deed). This may also include specifying the event or events that would trigger payment of the fee and how the fee is calculated. This may further include specifying how the fee is to be paid, such as by specifying where the fee is to be sent. The residual right may be reserved in any suitable manner, such as by granting or retaining the residual right in any appropriate title document or ownership certificate.

The residual right is recorded with the appropriate entity at step 506. This may include, for example, recording the deed or other title document or ownership certificate granting or retaining the residual right with a county government.

Although FIG. 5 illustrates one example of a method 500 for reserving a residual right associated with a property, various changes may be made to FIG. 5. For example, multiple residual rights could be associated with a single property. This may occur, for example, if the property is sold in multiple financed transfers. However, it is possible for one party to restrict or eliminate the ability of future parties to reserve a residual right in the property.

A residual right need not be held by, or even for the benefit of, the property owner reserving or otherwise separating the residual right. For example, a developer may wish to fund a service or amenity (such as a school, sporting facility, community center, hospital, or police or fire station) associated with a residential or commercial development. Accordingly, the developer may reserve a residual right in each lot sold as part of the development. These residual rights may entitle the holder to a payment from the owner of the lot periodically or on the occurrence of an event, such as upon resale of a lot/property. The developer may transfer the residual rights to an appropriate entity (such as an entity providing or maintaining the service or amenity) as a way of providing funding thereto. The residual right may, for example, establish that payments (such as a fixed amount, a percentage of the then current real property value, or an escalating scale) are due upon a second and all subsequent transfers of the real property, which may help to avoid a home builder owing the residual right payment but capturing all homeowners.

Although various embodiments have been described above with reference to “reserving” a residual right in a real property, it should be appreciated that such a residual right need not be “reserved” according to the disclosed embodiments. For example, it may be accurate to consider it “reserving” a residual right in a real property when an owner thereof is granting or separating a residual right from other rights being transferred to a buyer of the real property. However, an owner of real property may grant or separate a residual right from the remainder of rights in the real property at times other than when transferring the other rights in the real property. As a particular example, an owner of real property may grant or separate a residual right from other rights in real property owned by the owner to transfer the residual right to a third party (such as an architect designing a structure for the real property, a lender refinancing the real property or using the real property as collateral for a loan, a school district providing school facilities for residents of the real property, etc.). This may be done without the owner engaging in any other contemporaneous real property transaction (such as a mortgage, appraisal, etc.) or transfer.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
separating a residual right from other rights in a real property, the residual right representing an interest in the real property including a right to future payment associated with the real property without a right to use of any portion of the real property; and
facilitating a transaction using the residual right.

2. The method of claim 1, wherein facilitating the transaction comprises designing the residual right to return at least a difference between a value of the real property as perceived by a seller of the real property and a value of the real property as perceived by a buyer of the real property.

3. The method of claim 1, wherein facilitating the transaction comprises designing the residual right to return at least a difference between a financing fee desired by a lender associated with the transaction and a financing fee paid in association with the transaction.

4. The method of claim 1, wherein facilitating the transaction comprises designing the residual right to return at least a difference between a fee desired by a service provider providing a service associated with the transaction and a fee actually paid to the service provider.
